(19) United States
(12) Patent Application Publication
(10) Pub. No.: US 2004/0237943 A1
(43) Pub. Date: Dec. 2, 2004

(54) Self air-bleeding fuel supply system for a diesel engine with gravity primed fuel feed pump

(76) Inventors: Ramasamy Krishnamoorthy, Mumbai (IN); Prashant Subhash Khairnar, Chinchpada (IN); Krishnan Kumar Tiwari, Evershine City (IN)

Correspondence Address: Colin P. Abrahams, Suite 400, 5850 Canoga Avenue, Woodland Hills, CA, 91367, US

(21) Appl. No.: 10/682,375

(22) Filed: Oct. 9, 2003

(30) Foreign Application Priority Data
May 30, 2003 (IN) 548/MUM/2003

(51) Int. Cl. F02M 1/00

(52) U.S. Cl. 123/516

(57) ABSTRACT

A self air-bleeding fuel supply system for a diesel engine with gravity primed fuel feed pump to facilitate automatic priming of fuel feed pump and to completely eliminate manual operations involved for removal of entrapped air and to prime the fuel feed pump on refueling after complete utilizing fuel from the fuel tank.

### FIELD OF INVENTION

The present invention is about self air-bleeding fuel supply system for a diesel engine with gravity primed fuel feed pump. This system uses fewer numbers of parts, which makes system economical and also improves the serviceability and life of the system.

### BACKGROUND OF INVENTION

A fuel supply system of a diesel engine comprises of a fuel tank, feed pump, fuel filter, fuel injection pump, injectors and fuel pipes.

When the fuel tank is refueled after complete dry run of the above-mentioned system, it is required to remove the entrapped air from the system and prime the fuel feed pump. If the air is not removed from the system and also the priming of the fuel feed pump is not done, engine fails to start.

In the existing fuel supply systems, the air removal & priming is done manually. When the fuel tank is refueled after complete dry run, operator has to disconnect the fuel pipe connections manually and pump the manual fuel feed pump (which is sometimes called as priming pump) in order to prime the fuel feed pump and remove the entrapped air from the fuel supply system.

U.S. Pat. No. 5,899,193 discloses a fuel system and method for priming a diesel engine fuel system after assembly or when run out of fuel. The said system comprises a fuel tank enclosing a fuel feed pump with an outlet in an upper portion of the tank. The said system is provided with a fuel priming connection to the injection pump inlet. The connection has a closure for shutting the connection when not in use by means of a mechanically openable check valve, such as Schraeder valve. This valve is like the mechanically actuated type used in vehicle tyres to allow their inflation and prevent the escape of air unless actuated to an open position. To prime the fuel system after assembly, diesel fuel is delivered through the said check valve in the fuel supply system. This fuel flows back to the fuel tank through the filters, allowing to escape the trapped air from the system. The engine then may be started with minimum cranking.

After running out of fuel, the engine may be restarted by partially filling the tank and manually opening the said check valve. The feed pump is operated which forces the fuel to bleed air from system through this valve, which is closed prior to engine starting. The engine may then reprimed after shutdown if required. The said system involves manual operation. The feed pump enclosed in the fuel tank is difficult to access while carrying out maintenance.

U.S. Pat. No. 4,984,554 discloses an Automatic air bleeding device for fuel feed system of diesel engine. The said device is fitted in a fuel supply system, which has a check valve disposed in a suction-side line of a feed pump. The said check valve is a directional valve, which permits the fuel to direct only towards a feed pump. A bypass line is provided for bypassing the check valve; and an electrical pump is disposed in the bypass line. The said pump is connected parallel with the fuel feed pump, upstream of the check valve. As a result, when air intermixes in the fuel feed system, the said pump is energized prior to starting the engine to force the fuel having the air bubbles entrained though the feed pump into a fuel tank, thereby accomplishing air bleeding operation.

The said patent discloses an additional device for air bleeding, above-mentioned pump and hence the fuel supply system is not self air bleeding.

Indian Patent 16449 discloses an automatic air bleeding valve. The said valve is fitted in the fuel supply system. The said fuel supply system consists of a fuel tank from which the fuel flows to fuel filter, from fuel filter to fuel injection pump. The fuel injection pump pressurizes the fuel and supplies it to fuel injector. The said valve is fitted at the junction of inlet connection inlet pipe to the Fuel injection pump so as to remove air entrapped before Fuel injection pump.

In case of total dry run of fuel system, the said system may not work. The fuel may not flow through the minute pores of the filter by gravity. Therefore priming of the Fuel injection pump is not possible. Also, In case of clogging of the fuel filter, it will be difficult for fuel injection pump to suck the fuel from the Fuel filter.

Some manufacturers provide by-pass lines from fuel filter & fuel injection pump to remove entrapped air from system to the fuel tank. But the fuel feed pump can not be primed automatically, as there is a restriction of fuel filter before the fuel feed pump.

In the above discussed fuel supply systems no system is self priming without using any extra accessories/devices. Also there is no fuel supply system, which can bleed entrapped air itself without using any extra accessories/devices.

There exists a need of a fuel supply system, which will bleed the entrapped air itself without any extra accessories and/or devices and completely eliminates manual efforts for air bleeding and prime the fuel feed pump automatically.

The proposed self air-bleeding fuel supply system for a diesel engine with gravity primed fuel feed pump provides solution for above needs and has many advantages over the existing systems. These advantages are elaborated as below.

It eliminates the manual operations involved in priming the fuel feed pump and bleeding the air from the system. Priming of fuel feed pump takes place automatically after refueling without any extra devices/accessories and also eliminating the manual efforts. System itself bleeds the air thereby eliminating any extra device/accessories for air bleeding and also eliminates the manual efforts involved.

The proposed system avoids complications and uses fewer numbers of parts, which makes system economical and also improves the serviceability and life of the system.

### SUMMARY OF INVENTION

One aspect of the present invention is to provide a self air bleeding fuel supply system for a diesel engine and which also facilitate automatic priming of fuel feed pump.

One other aspect is to completely eliminate manual operations involved for removal of entrapped air and to prime the fuel feed pump on refueling after complete utilizing fuel from the fuel tank.

Another aspect of the present invention is to feed the fuel to the fuel feed pump using gravity.

Another aspect of the present invention is to bleed the entrapped air from fuel feed pump to fuel injection pump by forcing the fuel by feed pump.

Another aspect of the present invention is to position the filter after the fuel feed pump to remove restriction of filter to enable priming of the fuel feed pump automatically by using the gravity.

It is also an aspect of the present invention is to enable the fuel supply system to function despite clogging of fuel filter.

It is also an aspect of the present invention is to maintain fewer number of parts in the system in order to improve the reliability and serviceability.

Another aspect of the present invention to make self air bleeding fuel supply system by using fewer number of parts which makes it economical.

### BRIEF DESCRIPTION OF THE DRAWINGS

FIG. 1 shows the fuel supply system for diesel engine in accordance with the invention.

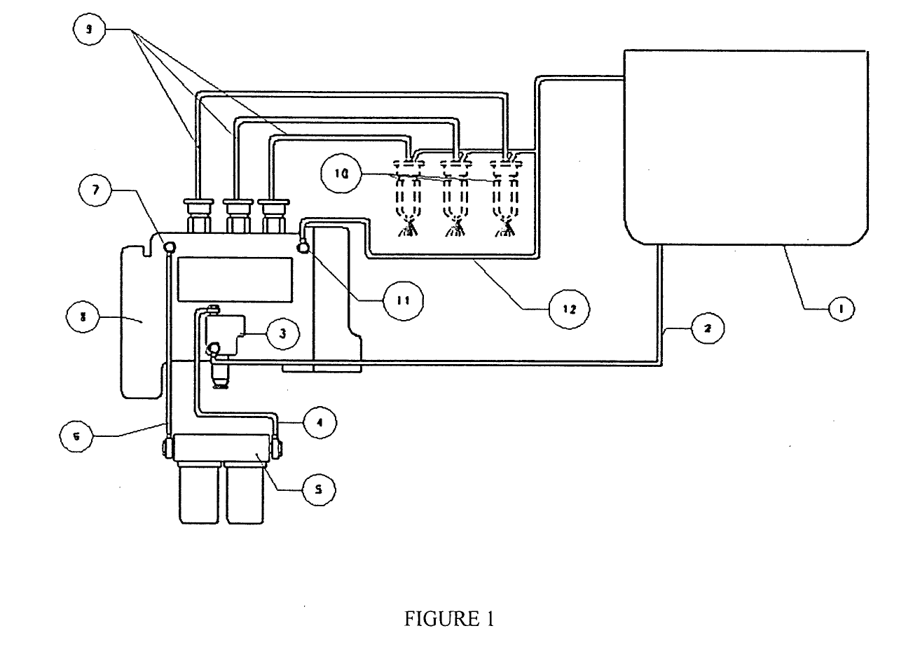

### DETAILED DESCRIPTION OF THE INVENTION

The system includes fuel tank 1 which acts as reservoir of fuel for fuel supply system. Fuel pipe 2 takes the fuel from fuel tank to fuel feed pump 3, which is mounted below the level of fuel tank. This specific arrangement of the fuel feed pump below the level of fuel tank enables free flow of fuel to fuel feed pump 3 by gravity hence automatically priming the fuel feed pump. The care has been taken to avoid any restriction between fuel tank 1 and fuel feed pump 3. In case of the prior arts, fuel filter is mounted between the fuel tank & fuel feed pump, which does not allow free flow of fuel to the fuel fed pump by gravity.

Fuel pipe 4 takes pressurized fuel from fuel feed pump to fuel filter 5. Fuel pipe 6 takes fuel from fuel filter 5 to fuel injection pump 8. A banjo bolt 7 facilitates the connection of fuel pipe 6 to fuel injection pump 8. Fuel injection pump 8 feeds fuel to engine via injectors 10 at a predetermined pressure. Fuel pipe 9 takes fuel from fuel injection pump 8 to the injectors 10. A banjo bolt 11 is also fitted on the fuel injection pump 8. This banjo bolt contains a pressure-regulating valve within it, which maintains a predefined pressure in the fuel injection pump 8. When the pressure in the fuel injection pump 8 goes higher than the predefined value the said valve opens against a spring and allows the extra fuel to pass to the fuel tank through the return line 12.

The advantage of the fuel filter 5 after the fuel feed pump 3 is that it will minimize the chances of starving of engine for fuel in case of filter clogging, as fuel feed pump will always try to force the fuel through the filters.

When the fuel in the fuel tank is completely utilized and the fuel system runs dry, refueling is done. In such conditions removal of entrapped air from the fuel system & priming of the fuel feed pump is necessary.

In the system mentioned above the position of fuel feed pump with respect to fuel tank and a micro-hole provided in the valve seat plays important role to make the system self air bleeding and fuel feed pump automatically primed.

After refueling the fuel from the fuel tank flows to the fuel feed pump 3 by gravity and primes it. As operator cranks the engine by turning the starting key, the fuel feed pump pressurizes the fuel and forces it through the entire system. The pressurized fuel forces the entrapped air in the system to the fuel injection pump 8. The micro-hole provided on the valve seat allows this entrapped air to escape through the return line 12 and hence facilitates automatic self air bleeding.

The present invention is not limited to the system described above and various modifications can be done without affecting the basic concept explained here. For instance the micro-hole provided on the valve seat is for the purpose of removal of air from the pressure side of the system without allowing the fuel to pass through it (because of very small hole size) . This kind of hole can be provided anywhere on the pressure side of the fuel supply system.

1. A self air bleeding fuel system, providing gravity priming of fuel feed pump.

2. A fuel system comprising of, Fuel feed pump 3 below the fuel tank 1, Fuel filter 5 after the fuel feed pump 3, fuel injection pump 8 after the fuel filter 5, injectors taking fuel from fuel injection pump 8, a banjo bolt 7 fitted on the fuel injection pump 8 containing a pressure regulating valve within it, the valve seat of the said valve contains a opening on it, a fuel return line 12 from the said banjo bolt 7 to fuel tank—in sequence.

3. A fuel system as defined in 2 above comprising of banjo bolt 7 mounted on the said fuel injection pump 8, containing a pressure valve within it. The valve seat of the said pressure valve containing an opening on it to allow the entrapped air to escape from the system.

4. An embodiment of system defined in 1 above containing, a hole provided at any place on the pressure side, to help escape of the entrapped air from the system.

5. An embodiment of system defined in 1 above wherein, banjo bolt 7 containing pressure-regulating valve is replaced by a directional valve of any having an opening allowing to escape the entrapped air.
